(19) United States
(12) Patent Application Publication
(10) Pub. No.: US 2003/0043014 A1
(43) Pub. Date: Mar. 6, 2003

(54) Pressure sensitive sensor

(76) Inventors: Tetsuzo Nakazawa, Tokyo (JP); Takashi Sato, Tokyo (JP); Akio Nakagawa, Tokyo (JP); Takaki Tsutsui, Tokyo (JP)

Correspondence Address: WHITHAM, CURTIS & CHRISTOFFERSON, P.C., 11491 SUNSET HILLS ROAD, SUITE 340, P.O. BOX 9204, RESTON, VA, 20190, US

(21) Appl. No.: 10/215,021

(22) Filed: Aug. 9, 2002

(30) Foreign Application Priority Data
Sep. 4, 2001 (JP) P2001-267822

(51) Int. Cl. H01C 10/10

(52) U.S. Cl. 338/47

(57) ABSTRACT

In a pressure sensitive sensor, a conductive pattern including a contact portion is provided on a substrate. A pressure-sensitive variable resistor is disposed above the substrate. An adhesive layer is coated on at least one of a lower face of the pressure-sensitive variable resistor or an upper face of the substrate so that the pressure-sensitive variable resistor is separated from the substrate, and so that a space is formed between the contact portion and the lower face of the pressure-sensitive variable resistor.

### BACKGROUND OF THE INVENTION

The present invention relates to a pressure sensitive sensor, and more particularly to the pressure sensitive sensor for use in a keyboard or a controller of a game machine, wherein a pressure-sensitive variable resistor is placed above a substrate, on which a conductive pattern is provided, so as to be away therefrom.

A related pressure sensitive sensor of such a type is described below with reference to FIGS. 3 and 4. As shown in FIG. 3, in a pressure sensitive sensor 1, a conductive pattern 3 is provided on a substrate 2. A spacer 6, which has holes 5 corresponding to contact portions 4 of the conductive pattern 3, is provided on the substrate 2. A pressure-sensitive variable resistor 7 is provided on the spacer 6. Therefore, as shown in FIG. 4, the pressure sensitive sensor 1 consists of four layers, that is, the substrate 2, the conductive pattern 3, the spacer 6 and the pressure-sensitive variable resistor 7. Each of the layers is suitably fixed.

When one of portions on the pressure-sensitive variable resistor 7, which respectively correspond to contact portions 4 of the conductive pattern 3, is depressed, the pressure-sensitive variable resistor 7 is bent at the hole 5 of the spacer 6, so that the portion on the pressure-sensitive variable resistor 7 is brought into contact with the corresponding contact portion 4 of the conductive pattern 3 through the hole 5. Thus, the contact portions 4 are electrically conducted by the contact so that the pressure sensitive sensor 1 outputs an ON-signal. When the pressure-sensitive variable resistor 7 is pushed down further, the pressure-sensitive variable resistor 7 is deformed by the compression. An electrostatic capacity of the pressure-sensitive variable resistor 7 is changed in accordance with the deformation thereof. Consequently, an analog output of the pressure sensitive sensor 1 is generated on the basis of change of the electrostatic capacity thereof.

However, the pressure sensitive sensor 1 uses the spacer 6 so as to cause the pressure-sensitive variable resistor 7 to be located at the predetermined distance from the substrate 2. Thus, the number of components of the pressure sensitive sensor 1 is increased by providing the spacer 6 therein as a component thereof. Moreover, the time and process required for assembling the sensor 1 is increased.

Furthermore, the spacer 6 has a predetermined thickness, so that the thickness of the pressure sensitive sensor 1 is increased by the thickness of the spacer 6. This hinders reduction in the thickness of the pressure sensitive sensor 1.

### SUMMARY OF THE INVENTION

It is therefore an object of the present invention to provide a pressure sensitive sensor in which the number of components of the pressure sensitive sensor and that of the time and processes required for assembling the pressure sensitive sensor is reduced, and cost and thickness of the pressure sensitive sensor is decreased.

In order to achieve the above object, according to the present invention, there is provided a pressure sensitive sensor comprising:

a substrate;

a conductive pattern, provided on the substrate, the conductive pattern including a contact portion;

a pressure-sensitive variable resistor, disposed above the substrate; and

an adhesive layer, coated on at least one of a lower face of the pressure-sensitive variable resistor or an upper face of the substrate so that the pressure-sensitive variable resistor is separated from the substrate, and so that a space is formed between the contact portion and the lower face of the pressure-sensitive variable resistor.

In the above configuration, a spacer to causes the pressure-sensitive variable resistor to be away from the substrate becomes unnecessary. Therefore, the number of components of the pressure sensitive sensor and that of the time and process required for assembling thereof are reduced. Further, the cost of the spacer is decreased. Moreover, the thickness of the adhesive layer can be set at an arbitrary value, so that the thickness of the pressure sensitive sensor can be reduced.

Preferably, the adhesive layer is provided with an aperture which is formed so as to avoid the contact portion of the conductive pattern.

In the above configuration, the pressure-sensitive variable resistor can be bent toward and be brought into contact with the contact portion so that the pressure sensitive sensor can output an ON-signal.

Preferably, the conductive pattern is a carbon-printed pattern. Thus, the pressure sensitive sensor, in which the conductive pattern is a carbon-printed pattern, is expected to attain the same advantages.

Also preferably, the conductive pattern is a plated pattern. Thus, the pressure sensitive sensor, in which the conductive pattern is a plated pattern, is expected to attain the same advantages.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is an exploded perspective view of a pressure sensitive sensor according to one embodiment of the present invention;

FIG. 2 is an exploded longitudinal sectional view of the pressure sensitive sensor according to the one embodiment of the present invention;

FIG. 3 is an exploded perspective view of a related pressure sensitive sensor; and

FIG. 4 is an exploded longitudinal sectional view of the related pressure sensitive sensor.

### DETAILED DESCRIPTION OF THE PREFERRED EMBODIMENTS

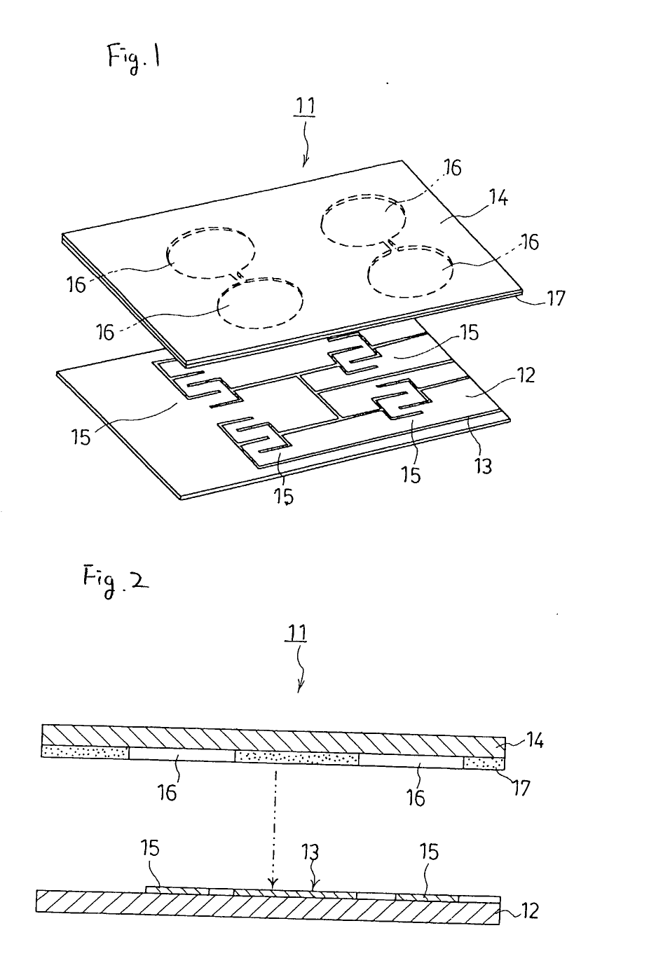

Preferred embodiments of the present invention will be described below in detail referring to FIGS. 1 and 2. In FIG. 1, a pressure sensitive sensor 11 is constructed so that a conductive pattern 13 made by carbon-printing or plating is provided on a substrate 12, and that a pressure-sensitive variable resistor 14 is disposed above the substrate 12 so as to be located at a predetermined distance therefrom. An adhesive 17 is applied on the entire rear face of the pressure-sensitive variable resistor 14 except non-applied portions 16 which are set at places corresponding to contact portions 15 of the conductive pattern 13. As shown in FIG. 2, the pressure sensitive sensor 11 is constituted by a four-layer structure consisting of the substrate 12, the conductive pattern 13, the adhesive 17 and the pressure-sensitive variable resistor 14.

Thus, when a portion of the pressure-sensitive variable resistor 14, which corresponds to the contact portion 15, is depressed, the pressure-sensitive variable resistor 14 is bent at the non-applied portion 16 so that the pressure-sensitive variable resistor 14 is brought into contact with the contact portion 15. The contact portion 15 is electrically conducted by the contact so that the pressure sensitive sensor 11 outputs an ON-signal. As the pressure-sensitive variable resistor 14 is further pushed down, the pressure-sensitive variable resistor 14 is deformed by the compression. The electrostatic capacity of the pressure-sensitive variable resistor 14 is changed in accordance with the deformation thereof. Consequently, an analog output of the pressure sensitive sensor is generated on the basis of change of the electrostatic capacity thereof.

Thus, the pressure sensitive sensor 11 is constructed so that the adhesive 17 is applied on the rear face of the pressure-sensitive variable resistor 14 except the non-applied portions 16. Consequently, the pressure-sensitive variable resistor 14 is fixed to the substrate 12. Moreover, the pressure-sensitive variable resistor 14 is caused by the adhesive layer made of adhesive 17 to be located at the predetermined distance therefrom to enable an bending operation of the pressure-sensitive variable resistor 14. Incidentally, the thickness of the applied adhesive 17 can be set at an arbitrary value.

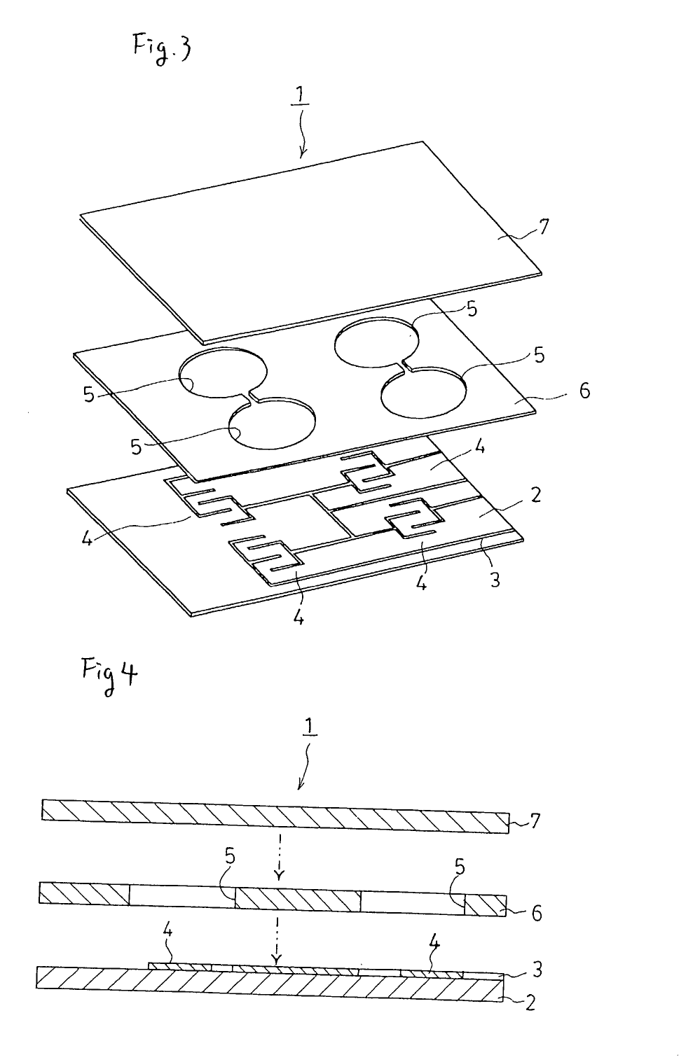

Therefore, in the pressure sensitive sensor 11, the spacer 6 shown in FIG. 3 becomes unnecessary. The number of components of the pressure sensitive sensor 11 and that of the time and process required for assembling thereof can be reduced. Further, the cost thereof can be decreased. Moreover, the thickness of the pressure sensitive sensor can be reduced.

Incidentally, as substitute for applying the adhesive 17 on the rear face of the pressure-sensitive variable resistor 14 in FIG. 2, it is possible to apply the adhesive 17 on an upper face of the substrate 12.

Moreover, various changes and modifications may be made without departing from the spirit of the invention. Further, needless to say, the invention covers the changes and modifications.

What is claimed is:

1. A pressure sensitive sensor, comprising:
a substrate;
a conductive pattern, provided on the substrate, the conductive pattern including a contact portion;
a pressure-sensitive variable resistor, disposed above the substrate; and
an adhesive layer, coated on at least one of a lower face of the pressure-sensitive variable resistor or an upper face of the substrate so that the pressure-sensitive variable resistor is separated from the substrate, and so that a space is formed between the contact portion and the lower face of the pressure-sensitive variable resistor.

2. The pressure sensitive sensor as set forth in claim 1, wherein the adhesive layer is provided with an aperture which is formed so as to avoid the contact portion of the conductive pattern.

3. The pressure sensitive sensor as set forth in claim 1, wherein the conductive pattern is a carbon-printed pattern.

4. The pressure sensitive sensor as set forth in claim 1, wherein the conductive pattern is a plated pattern.
